(19) United States
(12) Patent Application Publication
(10) Pub. No.: US 2023/0163420 A1
(43) Pub. Date: May 25, 2023

(54) STRUCTURAL UNIT CELL, ALL-SOLID-STATE BATTERY STACK AND METHOD FOR PRODUCING ALL-SOLID-STATE BATTERY STACK

(71) Applicant: TOYOTA JIDOSHA KABUSHIKI KAISHA, Toyota-shi Aichi-ken (JP)

(72) Inventors: Takumi Tanaka, Takarazuka-shi Hyogo-ken (JP); Yuichi Hasegawa, Otsu-shi Shiga-ken (JP)

(73) Assignee: TOYOTA JIDOSHA KABUSHIKI KAISHA, Toyota-shi Aichi-ken (JP)

(21) Appl. No.: 17/989,934

(22) Filed: Nov. 18, 2022

(30) Foreign Application Priority Data
Nov. 24, 2021 (JP) 2021-190450

(51) Int. Cl. H01M 50/477

(52) U.S. Cl. CPC H01M 50/477

(57) ABSTRACT

The present disclosure provides a structural unit cell, and an all-solid-state battery stack in which the structural unit cells are layered, whereby it is possible to inhibit dislocation during stacking and short circuiting. The structural unit cell comprises a first current collector layer, a first active material layer, a solid electrolyte layer, a second active material layer and a second current collector layer stacked in that order, and having an insulation frame which is disposed surrounding the outer periphery of the first active material layer, and is bonded to the first current collector layer and/or second current collector layer, wherein, as seen from the stacking direction, the first active material layer is disposed on the inner side of the outer periphery of the second active material layer, and the insulation frame has its inner periphery on the inner side of the outer periphery of the second active material layer.

### CROSS-REFERENCE TO RELATED APPLICATION

This application claims priority to Japanese Patent Application No. 2021-190450 filed Nov. 24, 2021, which is incorporated herein by reference in its entirety.

### FIELD

The present disclosure relates to a structural unit cell, to an all-solid-state battery stack and to a method for producing an all-solid-state battery stack.

### BACKGROUND

PTL 1 discloses a method for producing an all-solid-state battery comprising a positive electrode active material layer and a negative electrode active material layer with a greater area than the positive electrode active material layer, stacked via a solid electrolyte layer, wherein an insulator having a thickness of no greater than the positive electrode active material layer is situated in a portion of the void formed with the negative electrode active material layer around the outer peripheral section of the positive electrode active material layer, leaving a gap between the positive electrode active material layer and the insulator, and with a solid electrolyte layer provided between the positive electrode active material layer and the negative electrode active material layer including the insulator, and pressure is applied from both sides.

### CITATION LIST

### Patent Literature

[PTL 1] Japanese Unexamined Patent Publication No. 2015-162353

### SUMMARY

### Technical Problem

The present inventors have investigated production of all-solid-state battery stacks wherein a first current collector layer, a first active material layer, a solid electrolyte layer, a second active material layer and a second current collector layer are stacked in that order and the structure is such that a plurality of individual structural unit cells are layered each having a construction in which a first active material layer is disposed on the inner side of the outer periphery of the second active material layer, as seen from the stacking direction.

The production method disclosed in PTL 1 can be applied for this type of all-solid-state battery stack production.

However, the production method disclosed in PTL 1 assumes that deformation takes place during the pressing step due to pressure on the positive electrode active material layer and insulator. Therefore, the insulator and negative electrode active material layer are not bonded together prior to pressing, and this leads to a risk of dislocation during fabrication of the structural unit cells. Since the number of parts increases when an insulator is added, dislocation can also potentially occur during layering of the structural unit cells. When no insulator is present, the edges of the negative electrode active material layer in contact with the edges of the positive electrode active material layer can potentially bend by constraining pressure, resulting in damage to the solid electrolyte layer near the regions where the positive electrode active material layer edges contact the negative electrode active material layer.

It is an object of the disclosure to provide a structural unit cell, and an all-solid-state battery stack in which the structural unit cells are layered, whereby it is possible to inhibit dislocation during stacking and short circuiting within the all-solid-state battery stack, as well as a method for producing the all-solid-state battery stack.

### Solution to Problem

The present inventors have found that the aforementioned object can be achieved by the following:

### <Aspect 1>

A structural unit cell comprising a first current collector layer, a first active material layer, a solid electrolyte layer, a second active material layer and a second current collector layer stacked in that order, and

having an insulation frame which:

is disposed surrounding the outer periphery of the first active material layer, and

is bonded to the first current collector layer and/or second current collector layer, wherein, as seen from the stacking direction,

the first active material layer is disposed on the inner side of the outer periphery of the second active material layer, and

the insulation frame has its inner periphery on the inner side of the outer periphery of the second active material layer.

### <Aspect 2>

The structural unit cell according to mode 1, wherein

the insulation frame has:

a first insulation frame member which:

is disposed surrounding the outer periphery of the first active material layer and

is bonded to the first current collector layer, and

a second insulation frame member which:

is disposed surrounding the outer periphery of the second active material layer and

is bonded to the second current collector layer,

wherein the first insulation frame member and the second insulation frame member are bonded together.

### <Aspect 3>

The structural unit cell according to aspect 2, wherein:

a first conductive support layer is disposed between the first current collector layer and the first active material layer, and

the thickness of the first insulation frame member is no greater than the total of the thicknesses of the first active material layer and the first conductive support layer.

### <Aspect 4>

The structural unit cell according to aspect 2 or 3, wherein:

a second conductive support layer is disposed between the second current collector layer and the second active material layer, and

the thickness of the second insulation frame member is no greater than the total of the thicknesses of the second active material layer and the second conductive support layer.

### <Aspect 5>

An all-solid-state battery stack in which a plurality of structural unit cells according to any one of aspects 1 to 4 are stacked,

wherein the structural unit cells are disposed so that the outer peripheries of the respective insulation frames are aligned, as seen from the stacking direction.

### <Aspect 6>

A method for producing an all-solid-state battery stack, wherein the method includes stacking a plurality of structural unit cells according to any one of aspects 1 to 4 at the hollow portion of a positioning jig having a hollow portion that is complementary to the outer periphery of the insulation frame.

### [Effects]

The disclosure can provide a structural unit cell, and an all-solid-state battery stack in which the structural unit cells are layered, whereby it is possible to inhibit dislocation during stacking and short circuiting within the all-solid-state battery stack, as well as a method for producing the all-solid-state battery stack.

### BRIEF DESCRIPTION OF DRAWINGS

FIG. 1 is a schematic diagram of a structural unit cell 10 according to a first embodiment of the disclosure, as seen from the direction perpendicular to the stacking direction.

FIG. 2 is an exploded perspective view of a structural unit cell 10 according to the first embodiment.

FIG. 3 is a schematic diagram of a structural unit cell 20 according to a second embodiment of the disclosure, as seen from the direction perpendicular to the stacking direction.

FIG. 4 is a schematic diagram of a structural unit cell 30 according to a third embodiment of the disclosure, as seen from the direction perpendicular to the stacking direction.

FIG. 5A is a schematic diagram of an all-solid-state battery stack 100 according to the first embodiment, as seen from the direction perpendicular to the stacking direction.

FIG. 5B is a schematic diagram of an all-solid-state battery stack 100′ according to the second embodiment, as seen from the direction perpendicular to the stacking direction.

FIG. 6 is a schematic diagram of the structural unit cell 10 according to the first embodiment, as seen from the stacking direction.

FIG. 7 is a schematic diagram of a positioning jig 200 used for the first production method of the disclosure, as seen from the stacking direction of the all-solid-state battery stack 100 that is to be produced.

FIG. 8 is a schematic diagram showing part of the process for producing the all-solid-state battery stack 100 in the Examples.

FIG. 9 is a schematic diagram showing part of the process for producing the all-solid-state battery stack 100 in the Examples.

FIG. 10 is a schematic diagram showing part of the process for producing the all-solid-state battery stack 100 in the Examples.

FIG. 11 is a schematic diagram showing part of the process for producing the all-solid-state battery stack 100 in the Examples.

FIG. 12 is a schematic diagram showing part of the process for producing the all-solid-state battery stack 100 in the Examples.

FIG. 13 is a schematic diagram showing part of the process for producing the all-solid-state battery stack 100 in the Examples.

FIG. 14 is a schematic diagram showing part of the process for producing the all-solid-state battery stack 100 in the Examples.

FIG. 15 is a schematic diagram showing part of the process for producing the all-solid-state battery stack 100 in the Examples.

FIG. 16 is a schematic diagram showing part of the process for producing the all-solid-state battery stack 100 in the Examples.

FIG. 17 is a schematic diagram showing part of the process for producing the all-solid-state battery stack 100 in the Examples.

FIG. 18 is a schematic diagram showing part of the process for producing the all-solid-state battery stack 100 in the Examples.

### DESCRIPTION OF EMBODIMENTS

Embodiments of the disclosure will now be described in detail. The disclosure is not limited to the embodiments described below, however, and various modifications may be implemented which do not depart from the gist thereof

### <Structural Unit Cell>

### First Embodiment

The structural unit cell according to the first embodiment of the disclosure is a structural unit cell comprising a first current collector layer, a first active material layer, a solid electrolyte layer, a second active material layer and a second current collector layer stacked in that order, and having an insulation frame which is disposed surrounding the outer periphery of the first active material layer, is in contact with the solid electrolyte layer and is bonded to the first current collector layer and/or second current collector layer, wherein, as seen from the stacking direction, the first active material layer is disposed on the inner side of the outer periphery of the second active material layer, and the insulation frame has its inner periphery on the inner side of the outer periphery of the second active material layer.

In the structural unit cell of the first embodiment of the disclosure, the insulation frame is disposed surrounding the outer periphery of the first active material layer, is in contact with the solid electrolyte layer, and is bonded to the first current collector layer and/or second current collector layer.

With such a construction, the relative positions of the first active material layer and the first current collector layer and/or second current collector layer with respect to the insulation frame are fixed. When the all-solid-state battery stack is formed, therefore, the plurality of structural unit cells are stacked so that the outer frames of the insulation frames are aligned in the stacking direction, so that dislocation of the first active material layer and the first current collector layer and/or second current collector layer in the stacking direction of the all-solid-state battery stack is unlikely to occur. With a low degree of dislocation of the first active material layer, contact pressure produced by constraining pressure on the all-solid-state battery stack tends to be more evenly applied to the first active material layer, thus improving the function of the all-solid-state battery stack.

In a structural unit cell according to the first embodiment of the disclosure, the first active material layer is disposed on the inner side of the outer periphery of the second active material layer and the insulation frame has the inner periphery on the inner side of the outer periphery of the second active material layer, as seen from the stacking direction.

When the shape of the structural unit cell has a construction in which the first active material layer is disposed on the inner side of the outer periphery of the second active material layer, as seen from the stacking direction, the edges of the second active material layer and solid electrolyte layer often bend toward the first active material layer side by constraining pressure during formation of the all-solid-state battery stack. Such deformation of the second active material layer and solid electrolyte layer causes deformation and destruction of the second active material layer and solid electrolyte layer, thereby potentially resulting in contact between the first active material layer and second active material layer. Contact between the first active material layer and second active material layer leads to short circuiting of the structural unit cell.

A structural unit cell according to the first embodiment has an insulation frame that is disposed surrounding the outer periphery of the first active material layer, and has its inner periphery on the inner side of the outer periphery of the second active material layer. The insulation frame inhibits bending of the edges of the second active material layer toward the first active material layer side by constraining pressure during formation of the all-solid-state battery stack.

When the first current collector and first active material layer are a positive electrode collector layer and positive electrode active material layer, respectively, the second current collector and second active material layer are a negative electrode collector layer and negative electrode active material layer, respectively. When the first current collector and first active material layer are a negative electrode collector layer and negative electrode active material layer, respectively, the second current collector and second active material layer are a positive electrode collector layer and positive electrode active material layer, respectively. In some embodiments, the first current collector and first active material layer are a positive electrode collector layer and positive electrode active material layer, respectively, and the second current collector and second active material layer are a negative electrode collector layer and negative electrode active material layer, respectively.

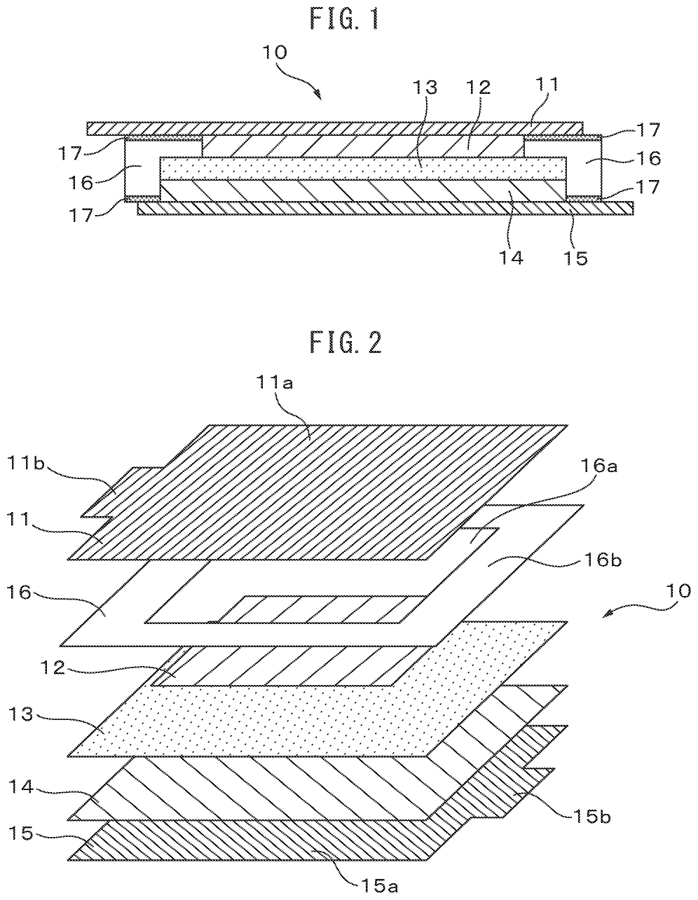

FIG. 1 is a schematic diagram of a structural unit cell 10 according to the first embodiment of the disclosure, as seen from the direction perpendicular to the stacking direction. FIG. 2 is an exploded perspective view of a structural unit cell 10 according to the first embodiment.

As shown in FIGS. 1 and 2, the structural unit cell 10 of the first embodiment is a structural unit cell 10 comprising a first current collector layer 11, first active material layer 12, solid electrolyte layer 13, second active material layer 14 and second current collector layer 15 stacked in that order. The insulation frame 16 is disposed surrounding the outer periphery of the first active material layer 12, is in contact with the solid electrolyte layer 13, and is bonded to the first current collector layer 11 and second current collector layer 15. As seen from the stacking direction of the structural unit cell 10, the first active material layer 12 is disposed on the inner side of the outer periphery of the second active material layer 14. As seen from the stacking direction of the structural unit cell 10, the insulation frame 16 has its inner periphery on the inner side of the outer periphery of the second active material layer 14.

In FIG. 1, the insulation frame 16 is bonded to the first current collector layer 11 and second current collector layer 15 via a bonding agent 17. The thickness of the insulation frame 16 is the same as the thickness of the first active material layer 12 including the bonding agent 17. In other words, the insulation frame 16 is in contact with the solid electrolyte layer 13 while being bonded to the first current collector layer 11. As seen from the stacking direction of the structural unit cell 10, the outer periphery of the insulation frame 16 is further outward than the outer periphery of the solid electrolyte layer 13 and second active material layer 14. The insulation frame 16 has a frame-like shape, as shown in FIG. 2. That is, the insulation frame 16 has a frame portion 16b and a hollow portion 16a.

FIGS. 1 and 2 are not intended to limit the structural unit cell of the disclosure.

### (First Current Collector Layer)

The first current collector layer is a positive electrode collector layer or negative electrode collector layer.

The first current collector layer may be made of any publicly known metal or carbon material that can be used as a current collector layer for an all-solid-state battery. Examples of metals include metal materials comprising one or more elements selected from the group consisting of copper, nickel, aluminum, vanadium, gold, platinum, magnesium, iron, titanium, cobalt, chromium, zinc, germanium and indium. Carbon materials may be any conductive carbon materials, such as carbon.

In some embodiments, when the first current collector layer is a positive electrode collector layer, the first current collector layer is stainless steel, aluminum, nickel, iron, titanium or carbon, for example. In some embodiments, when the first current collector layer is a negative electrode collector layer, the first current collector layer is stainless steel, copper or nickel, for example.

The first current collector layer has a shape corresponding to the first active material layer, and with the outer periphery matching that of the first active material layer, or with the outer periphery being a shape having a current collector on the outer side of the outer periphery of the first active material layer and a collector tab for connection to the terminal. The collector tab may protrude out from the current collector. More specifically, the first current collector layer 11 may have a current collector 11a and a collector tab 11b as shown in FIG. 2, for example.

In some embodiments, the first current collector layer has the current collector disposed further toward the inner side than the outer periphery of the insulation frame, as seen from the stacking direction of the structural unit cells. This is in order to inhibit contact between the first current collector layer and the second active material layer or second current collector layer when the all-solid-state battery stack has been formed.

### (First Active Material Layer)

The first active material layer is disposed on the inner side of the outer periphery of the second active material layer, as seen from the stacking direction.

The first active material layer is a positive electrode active material layer or a negative electrode active material layer. In some embodiments, from the viewpoint of inhibiting short circuiting, the size of the positive electrode active material layer is smaller than the size of the negative electrode active material layer, as seen from the stacking direction. In some embodiments, the first active material layer is therefore a positive electrode active material layer.

The first active material layer includes an active material, and may also include a solid electrolyte, conductive aid and binder as optional components.

When the first active material layer is a positive electrode active material layer, the first active material layer includes a positive electrode active material. The type of positive electrode active material is not particularly restricted and may be any material that can be used as an active material for an all-solid-state battery.

Examples of positive electrode active materials include lithium compounds, examples of which are LiCoO₂, LiNiₓCo₁₋ₓO₂ (0<x<1), LiNi_{1/3}Co_{1/3}Mn_{1/3}O₂, LiMnO₂, heterogenous element-substituted Li—Mn spinel (such as LiMn_{1.5}Ni_{0.5}O₄, LiMn_{1.5}Al_{0.5}O₄, LiMn_{1.5}Mg_{0.5}O₄, LiMn_{1.5}Co_{0.504}, LiMn_{1.5}Fe_{0.504} and LiMn_{1.5}Zn_{0.504}), and lithium phosphates (such as LiFePO₄, LiMnPO₄, LiCoPO₄ and LiNiPO₄), and also transition metal oxides (such as V₂O₅ and MoO₃).

The form of the positive electrode active material is not particularly restricted and may be particulate, for example.

The surface of the positive electrode active material may also have a coating layer comprising a lithium ion conductive oxide. This will allow reaction between the positive electrode active material and solid electrolyte to be inhibited.

Examples of lithium ion conductive oxides include LiNbO₃, Li₄Ti₅O₁₂ and Li₃PO₄. The thickness of the coating layer may be 0.1 nm or greater, or 1 nm or greater, for example. The thickness of the coating layer may also be 100 nm or smaller, or 20 nm or smaller, for example. The coverage factor of the coating layer on the surface of the positive electrode active material may be 70% or greater or 90% or greater, for example.

Examples of solid electrolytes include solid electrolytes that may be included in the solid electrolyte layer as described below.

The content of the solid electrolyte in the positive electrode active material layer is not particularly restricted and may be in the range of 1 mass % to 80 mass %, for example, where 100 mass % is the total mass of the positive electrode active material layer.

When the first active material layer is a negative electrode active material layer, the first active material layer includes a negative electrode active material.

The material for the negative electrode active material is not particularly restricted, and it may be lithium metal, or any material capable of occluding and releasing metal ions such as lithium ions. Examples of materials capable of occluding and releasing metal ions such as lithium ions include, but are not limited to, lithium compounds such as Li₄Ti₅O₁₂, alloy-based negative electrode active materials and carbon materials, which are negative electrode active materials.

Alloy-based negative electrode active materials are not particularly restricted, and examples include Si alloy-based negative electrode active materials and Sn alloy-based negative electrode active materials. Si alloy-based negative electrode active materials include silicon, silicon oxides, silicon carbides, silicon nitrides, and their solid solutions. An Si alloy-based negative electrode active material may also include elements other than silicon, such as Fe, Co, Sb, Bi, Pb, Ni, Cu, Zn, Ge, In, Sn and Ti, for example. Sn alloy-based negative electrode active materials include tin, tin oxides, tin nitrides, and their solid solutions. A Sn alloy-based negative electrode active material may also include elements other than tin, such as Fe, Co, Sb, Bi, Pb, Ni, Cu, Zn, Ge, In, Ti and Si, for example. In some embodiments, Si alloy-based negative electrode active materials are used among these.

Carbon materials are not particularly restricted and include hard carbon, soft carbon and graphite, for example.

The solid electrolyte used may be any one mentioned below for the solid electrolyte layer.

The conductive aid used may be a publicly known one, such as a carbon material or metallic particles, for example. The carbon material may be one or more selected from the group consisting of carbon blacks such as acetylene black and furnace black, vapor-deposited carbon fibers, carbon nanotubes and carbon nanofibers, among which one or more selected from the group consisting of vapor-deposited carbon fibers, carbon nanotubes and carbon nanofibers are suitable from the viewpoint of electron conductivity. Metallic particles may be particles of nickel, copper, iron or stainless steel.

The conductive aid content of the first active material layer is not particularly restricted.

Examples for the binder include, but are not limited to, materials such as polyvinylidene fluoride (PVdF), carboxymethyl cellulose (CMC), butadiene rubber (BR) and styrene-butadiene rubber (SBR), or combinations thereof.

The binder content of the first active material layer is also not particularly restricted.

### (Solid Electrolyte Layer)

The solid electrolyte layer comprises a solid electrolyte.

In some embodiments, the solid electrolyte is an inorganic solid electrolyte. Examples of inorganic solid electrolytes include sulfide solid electrolytes, oxide solid electrolytes and nitride solid electrolytes.

The sulfide solid electrolyte will usually contain Li element and S element. In some embodiments, the sulfide solid electrolyte comprises at least one among P element, Ge element, Sn element and Ge element and Si element. The sulfide solid electrolyte may also comprise at least one halogen element (such as F element, Cl element, Br element or I element).

Examples of sulfide solid electrolytes include Li₂S—P₂S₅, Li₂S—P₂S₅—GeS₂, Li₂S—P₂S₅—SnS₂, Li₂S—P₂S₅SiS₂, Li₂S—P₂S₅—LiI, Li₂S—P₂S₅—LiI—LiBr, Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—Li₂S—B₂S₃ and Li₂S—P₂S₅—ZₘSₙ (where m and n are positive integers and Z is Ge, Zn or Ga), and Li₂S—GeS₂, Li₂S—SiS₂—Li₃PO₄ and Li₂S—SiS₂-LiₓMO_{y} (where x and y are positive integers and M is P, Si, Ge, B, Al, Ga or In). The notation “Li₂S—P₂S₅” means a material obtained using a raw material composition containing Li₂S and P₂S₅, with corresponding meaning for the other notations.

The solid electrolyte may be glass, or glass ceramic, or a crystal material. Glass can be obtained by amorphous processing of the raw material composition (such as a mixture of Li₂S and P₂S₅). Examples of amorphous processing include mechanical milling. Mechanical milling may be dry mechanical milling or wet mechanical milling. This is in order to help prevent adhesion of the raw material composition to the wall faces of containers. Glass ceramic can be obtained by heat treatment of glass. A crystal material can be obtained by solid phase reaction treatment of the raw material composition, for example.

The solid electrolyte content in the solid electrolyte layer may be 70 wt % or greater or 90 wt % or greater, for example.

The solid electrolyte layer may also comprise a binder if necessary. Examples for the binder include, but are not limited to, materials such as polyvinylidene fluoride (PVdF), carboxymethyl cellulose (CMC), butadiene rubber (BR) and styrene-butadiene rubber (SBR), or combinations thereof.

### (Second Active Material Layer)

The second active material layer is a positive electrode active material layer or a negative electrode active material layer. When the first active material layer is a positive electrode active material layer, the second active material layer is a negative electrode active material layer. The composition and material for the second active material layer may be the same as described above for the first active material layer.

### (Second Current Collector Layer)

The first current collector layer is a positive electrode collector layer or negative electrode collector layer. When the first current collector layer is a positive electrode collector layer, the second current collector layer is a negative electrode collector layer. The composition and material for the second current collector layer may be the same as described above for the first current collector layer.

The second current collector layer has a shape corresponding to the second active material layer, and with the outer periphery matching that of the second active material layer, or with the outer periphery being a shape having a current collector on the outer side of the outer periphery of the second active material layer and a collector tab for connection to the terminal. The collector tab may protrude out from the current collector. More specifically, the second current collector layer 15 may have a current collector 15a and a collector tab 15b as shown in FIG. 2, for example.

In some embodiments, the second current collector layer has the current collector disposed further toward the inner side than the outer periphery of the insulation frame, as seen from the stacking direction of the structural unit cells. This is in order to inhibit contact between the second current collector layer and the first active material layer or first current collector layer when the all-solid-state battery stack has been formed.

### (Insulation Frame)

The insulation frame is disposed surrounding the outer periphery of the first active material layer, and is bonded to the first current collector layer and/or second current collector layer. As seen from the stacking direction of the structural unit cell, the insulation frame has its inner periphery on the inner side of the outer periphery of the second active material layer.

The insulation frame may partially or completely surround the outer periphery of the first active material layer. In some embodiments, from the viewpoint of inhibiting contact between the first active material layer and second active material layer when the all-solid-state battery stack has been formed, of course, the insulation frame is disposed surrounding the entire outer periphery of the first active material layer. In some embodiments, the insulation frame has a frame-like shape as shown in FIG. 2, or in other words it has a frame portion 16b and a hollow portion 16a.

In some embodiments, from the viewpoint of inhibiting dislocation of the first active material layer during formation of the all-solid-state battery stack, the inner periphery of the insulation frame is further outward than the outer periphery of the first active material layer, and either the same size as or slightly larger than the outer periphery of the first active material layer. When the inner periphery of the insulation frame is slightly larger than the outer periphery of the first active material layer, the maximum distance between the inner periphery of the insulation frame and the outer periphery of the first active material layer may be 1000 μm or less, 100 or less, 50 μm or less, 25 μm or less or 10 μm or less, for example. The maximum distance between the inner periphery of the insulation frame and the outer periphery of the first active material layer is naturally a positive value, i.e. larger than zero.

In some embodiments, the thickness of the insulation frame is no greater than the thickness of the first active material layer, and in some embodiments they are equal. The thickness of the insulation frame may be 50 to 100% of the thickness of the first active material layer. When the insulation frame is bonded to the first current collector layer with a bonding agent, the thickness is the total thickness of the insulation frame and bonding agent.

If the thickness of the insulation frame is at least 50% of the thickness of the first active material layer it will be possible to further inhibit the degree of bending of the second active material layer toward the first active material layer side during formation of the all-solid-state battery stack. If the thickness of the insulation frame is no greater than 100% of the thickness of the first active material layer, on the other hand, it will be possible to inhibit load applied in the stacking direction of the all-solid-state battery stack from being concentrated on the insulation frame, when the all-solid-state battery stack is constrained by an end plate from the stacking direction, thus making it easier to apply contact pressure onto the first and second active material layers and the solid electrolyte layer.

The thickness of the insulation frame may be at least 50%, at least 60%, at least 70% or at least 80% of the thickness of the first active material layer. The thickness of the insulation frame may also be up to 100%, up to 90%, up to 80% or up to 70% of the thickness of the first active material layer.

The material of the insulation frame is not particularly restricted so long as it is an insulating material, and it may be an insulating polymer sheet, for example. Examples of insulating polymer sheets include, but are not limited to, polyimide and polyethylene terephthalate (PET).

When the insulation frame is to be bonded to the first current collector layer and/or second current collector layer with a bonding agent, the bonding agent used may be any bonding agent that is commonly used for assembly of all-solid-state batteries. Such a bonding agent may be one comprising a thermoplastic resin, for example. Examples of thermoplastic resins include, but are not limited to, polyolefin-based resins such as ethylene-vinyl acetate copolymer (EVA) and low-density polyethylene (LDPE).

### (Production of Structural Unit Cell)

The structural unit cell of the disclosure can be produced by the following method. The following production method is not intended to limit the structural unit cell of the disclosure.

First, a stack is formed by layering a first active material layer, solid electrolyte layer and second active material layer in that order, using a publicly known method.

The first active material layer and second active material layer can be formed by coating a substrate with an active material slurry prepared by mixing an active material, solid electrolyte, conductive material and binder, as well as a dispersing medium, and drying and pressing it.

The solid electrolyte layer can be formed by coating a substrate with a solid electrolyte slurry prepared by mixing a solid electrolyte and a binder, as well as a dispersing medium, and drying and pressing it.

A stack can also be formed by transferring each layer. The second active material layer and solid electrolyte layer have larger areas than the first active material layer. Specifically, when layering, the outer periphery of the first active material layer is formed on the inner side of the outer periphery of the second active material layer and solid electrolyte layer.

The insulation frame is then placed over the stack from the first active material layer side. The first active material layer is fitted on the hollow portion of the insulation frame. The first current collector layer is disposed on the first active material layer side of the stack, and the second current collector layer is disposed on the second active material layer side. The first current collector layer and/or second current collector layer are bonded to the insulation frame by a bonding agent, for example.

### Second Embodiment

The structural unit cell of the second embodiment may have the following construction, in addition to the structural unit cell of the first embodiment:

The insulation frame has a first insulation frame member which is disposed surrounding the outer periphery of the first active material layer and is bonded to the first current collector layer, and a second insulation frame member which is disposed surrounding the outer periphery of the second active material layer and is bonded to the second current collector layer, wherein the first insulation frame member and the second insulation frame member are bonded together.

Specifically, the insulation frame in the structural unit cell of the second embodiment is formed by the first insulation frame member and second insulation frame member. This type of construction allows the bonding agent layer, used to fill the area between the insulation frame and second current collector layer, to be reduced in thickness, and eliminates the need to bend the insulation frame along the outer periphery of the second active material layer. This facilitates bonding between the insulation frame and the second current collector layer.

The structural unit cell of the second embodiment is particularly useful when the thickness of the solid electrolyte layer and/or second active material layer is larger than the thickness of the first active material layer.

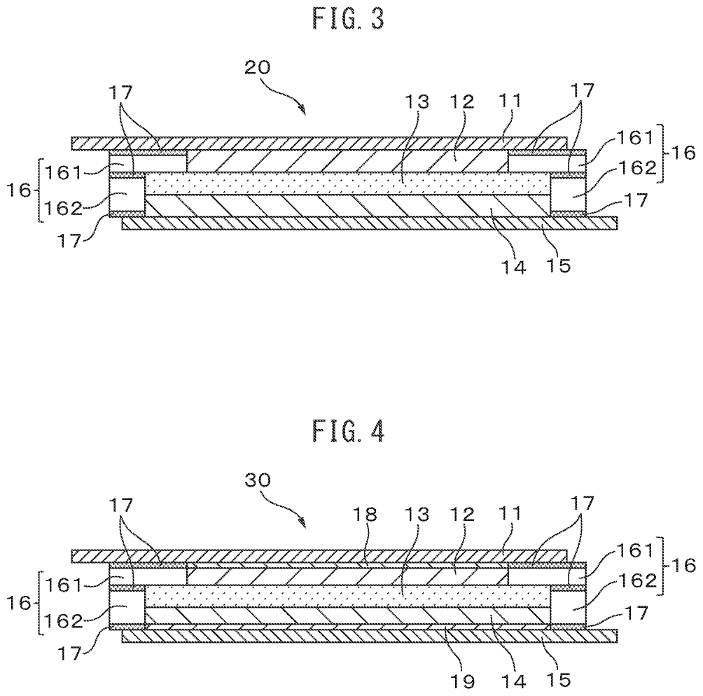

FIG. 3 is a schematic diagram of a structural unit cell 20 according to the second embodiment, as seen from the direction perpendicular to the stacking direction.

In the structural unit cell 20 of the second embodiment, the insulation frame 16 is disposed surrounding the outer periphery of the first active material layer 12. The insulation frame 16 has a first insulation frame member 161 bonded to the first current collector layer 11, and a second insulation frame member 162 disposed surrounding the outer periphery of the second active material layer 14 and bonded to the second current collector layer 15. The first insulation frame member 161 and second insulation frame member 162 are bonded together by the bonding agent 17.

FIG. 3 is not intended to limit the structural unit cell of the disclosure.

In some embodiments, when the structural unit cell is seen from the stacking direction, the outer periphery of the second insulation frame member either aligns with the outer periphery of the first insulation frame member, or it forms the inner side of the outer periphery of the first insulation frame member.

If the outer periphery of the second insulation frame member either aligns with the outer periphery of the first insulation frame member or forms its inner side, it will be easier to stack a plurality of structural unit cells along the outer periphery of the insulating property member, i.e. in a manner such that the outer peripheries of the insulating property members are aligned in the stacking direction, when forming the all-solid-state battery stack. This will help to inhibit dislocation of the first active material layer.

### Third Embodiment

The structural unit cell of the third embodiment may have the following construction, in addition to the structural unit cell of the second embodiment:

The first conductive support layer is disposed between the first current collector layer and the first active material layer, and the thickness of the first insulation frame member is no greater than the total of the thicknesses of the first active material layer and the first conductive support layer.

The structural unit cell of the third embodiment has the first conductive support layer disposed between the first current collector layer and the first active material layer, in addition to the construction of the structural unit cell of the second embodiment. The first conductive support layer may directly utilize the substrate for formation of the first active material layer.

In the structural unit cell of the third embodiment, the thickness of the first insulation frame member is no greater than the total of the thicknesses of the first active material layer and first conductive support layer. When the first insulation frame member is bonded to the first current collector layer with a bonding agent, the thickness of the first insulation frame member includes the thickness of the bonding agent.

If the thickness of the first insulation frame is no greater than the total of the thicknesses of the first active material layer and first conductive support layer, then it will be possible to inhibit load applied in the stacking direction of the all-solid-state battery stack from being concentrated on the first insulation frame when the all-solid-state battery stack is constrained by an end plate from the stacking direction, thus making it easier to apply contact pressure onto the first active material layer.

FIG. 4 is a schematic diagram of a structural unit cell 30 according to the third and fourth embodiments of the disclosure, as seen from the direction perpendicular to the stacking direction.

As shown in FIG. 4, the structural unit cell 30 of the third and fourth embodiments has a first conductive support layer 18 disposed between the first current collector layer 11 and the first active material layer 12, and the thickness of the first insulation frame member 161 is no greater than the total of the thicknesses of the first active material layer 12 and first conductive support layer 18.

FIG. 4 is not intended to limit the structural unit cell of the disclosure.

### Fourth Embodiment

The structural unit cell of the fourth embodiment may have the following construction, in addition to the structural unit cell of the second or third embodiment:

The second conductive support layer is disposed between the second current collector layer and the second active material layer, and the thickness of the second insulation frame member is no greater than the total of the thicknesses of the second active material layer and the second conductive support layer.

The structural unit cell of the fourth embodiment has the second conductive support layer disposed between the second current collector layer and the second active material layer, in addition to the construction of the structural unit cell of the second or third embodiment. The second conductive support layer may directly utilize the substrate for formation of the second active material layer.

In the structural unit cell of the fourth embodiment, the thickness of the second insulation frame member is no greater than the total of the thicknesses of the second active material layer and second conductive support layer. When the second insulation frame member is bonded to the second current collector layer with a bonding agent, the thickness of the second insulation frame member includes the thickness of the bonding agent.

If the thickness of the second insulation frame is no greater than the total of the thicknesses of the second active material layer and second conductive support layer, then it will be possible to inhibit load applied in the stacking direction of the all-solid-state battery stack from being concentrated on the second insulation frame, when the all-solid-state battery stack is constrained by an end plate from the stacking direction, thus making it easier to apply contact pressure onto the second active material layer.

FIG. 4 is a schematic diagram of a structural unit cell 30 according to the third and fourth embodiments of the disclosure, as seen from the direction perpendicular to the stacking direction.

As shown in FIG. 4, the structural unit cell 30 of the third and fourth embodiments have a second conductive support layer 19 disposed between the second current collector layer 15 and the second active material layer 14, and the thickness of the second insulation frame member 162 is no greater than the total of the thicknesses of the second active material layer 14 and second conductive support layer 19.

FIG. 4 is not intended to limit the structural unit cell of the disclosure.

### <All-Solid-State Battery Stack>

The all-solid-state battery stack of the disclosure is an all-solid-state battery stack in which a plurality of structural unit cells of the disclosure are stacked, wherein the structural unit cells are disposed so that the outer peripheries of the respective insulation frames are aligned, as seen from the stacking direction.

In the all-solid-state battery stack of the disclosure, the structural unit cells of the disclosure are disposed so that the outer peripheries of the respective insulation frames are aligned. As a result, the first active material layers of the structural unit cells exhibit a low degree of dislocation as seen from the stacking direction of the all-solid-state battery stack. In other words, there is minimal shifting of the outer peripheries of the first active material layers of the structural unit cells, as seen from the stacking direction of the all-solid-state battery stack.

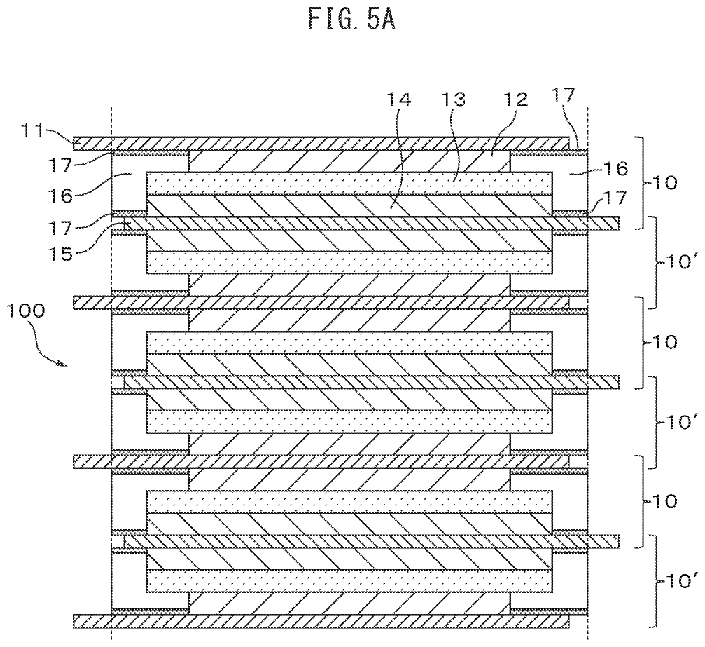

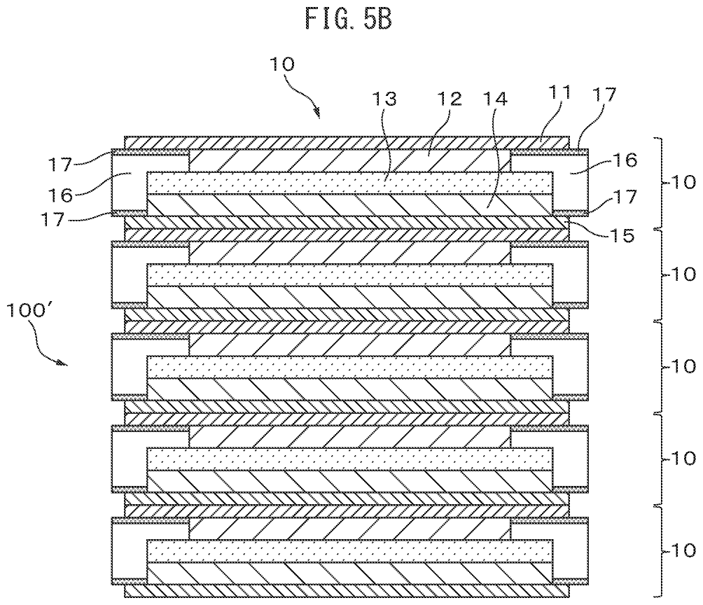

FIG. 5A is a schematic diagram of an all-solid-state battery stack 100 according to the first embodiment, as seen from the direction perpendicular to the stacking direction.

As shown in FIG. 5A, the all-solid-state battery stack 100 of the first embodiment has a construction in which a plurality of structural unit cells 10 and 10′ according to the first embodiment are alternately stacked. In FIG. 5A, the mutually adjacent structural unit cells 10 and 10′ share a first current collector layer 11 and second current collector layer 15. As represented by the broken lines, the structural unit cell 10 and 10′ have the outer peripheries of their respective insulation frames 16 aligned, as seen from the stacking direction.

FIG. 5B is a schematic diagram of an all-solid-state battery stack 100′ according to the second embodiment, as seen from the direction perpendicular to the stacking direction.

As shown in FIG. 5B, the all-solid-state battery stack 100′ of the second embodiment has a construction in which a plurality of structural unit cells 10 according to the first embodiment are stacked in series. The stacking is such that the first current collector layers 11 and second current collector layers 15 of adjacent structural unit cells 10 are in contact. While not shown in FIG. 5B, the all-solid-state battery stack 100′ of the second embodiment may have the first current collector layer 11 of one structural unit cell 10 also serving as the second current collector layer 15 of another structural unit cell 10, for mutually adjacent structural unit cells 10. As represented by the broken lines, the structural unit cells 10 have the outer peripheries of their respective insulation frames 16 aligned, as seen from the stacking direction.

FIGS. 5A and B are not intended to limit the structural unit cell and all-solid-state battery stack of the disclosure.

While not shown in FIGS. 5A and B, the all-solid-state battery stack of the disclosure may also have a pair of end plates disposed on both sides in the stacking direction. The end plates may be fastened with constraining pressure on the all-solid-state battery stack in the stacking direction.

The method for producing the all-solid-state battery stack of the disclosure may be, but is not limited to, the method described below under <Method for producing all-solid-state battery stack>.

<Method for Producing all-Solid-State Battery Stack>

The production method of the disclosure is a method for producing an all-solid-state battery stack which includes stacking a plurality of structural unit cells of the disclosure at the hollow portion of a positioning jig having a hollow portion that is complementary to the outer peripheries of the insulation frames. When the collector tabs of the first current collector layer and/or second current collector layer protrude out from the outer peripheries of the insulation frames as seen from the stacking direction of the structural unit cell, the positioning jig may have a hollow portion that is complementary to the shape matching the outer peripheries of the insulation frames and the outer peripheries of the collector tabs of the first current collector layers and/or second current collector layers.

The production method of the disclosure uses a positioning jig having a hollow portion that is complementary to the outer peripheries of the insulation frames, to stack structural unit cells of the disclosure in the hollow portion, and therefore each of the stacked structural unit cells have the outer peripheries of their insulation frames aligned, as seen from the stacking direction. It is therefore easy to have the structural unit cells of the disclosure disposed so that the respective outer peripheries of the insulation frames are aligned.

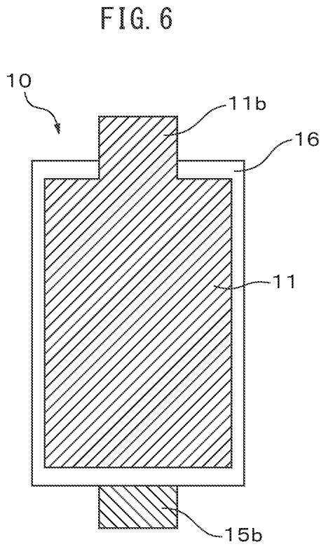

FIG. 6 is a schematic diagram of the structural unit cell 10 according to the first embodiment, as seen from the stacking direction.

As shown in FIG. 6, the outer periphery of the structural unit cell 10 is equivalent to the outer periphery of the insulation frame 16, except that the collector tabs 11b and 15b of the first current collector layer 11 and second current collector layer 15 protrude out from the insulation frame 16, as viewed in the stacking direction.

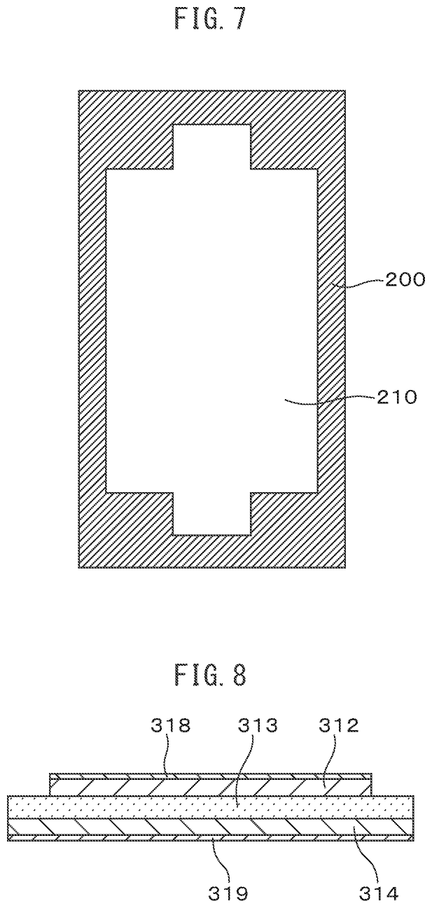

FIG. 7 is a schematic diagram of a positioning jig 200 used for the first production method of the disclosure, as seen from the stacking direction of the all-solid-state battery stack 100 that is to be produced.

As shown in FIG. 7, the positioning jig 200 has a hollow portion 210 having a shape complementary to the combined shape of the outer periphery of the insulation frame 16, and the outer peripheries of the collector tabs 11b and 15b of the first current collector layer 11 and second current collector layer 15.

FIGS. 6 and 7 are not intended to limit the structural unit cell, all-solid-state battery stack and production method of the disclosure.

The production method of the disclosure forms an all-solid-state battery stack by stacking a plurality of structural unit cells at the hollow portion of a positioning jig. Each of the structural unit cells may be bonded with a bonding agent, for example. After the plurality of structural unit cells have been stacked, an end plate is inserted at both sides in the stacking direction and constraining pressure is applied to fasten them.

When the structural unit cells are stacked in the production method of the disclosure, they are stacked so that any two adjacent structural unit cells in the stacking direction are oriented the same in the stacking direction.

### EXAMPLES

### Examples 1 and 2

### Example 1

A structural unit cell was fabricated for Example 1 in the following manner.

A positive electrode active material slurry was prepared by mixing nickel cobalt manganate (NCM) as the positive electrode active material, and a sulfide solid electrolyte, conductive aid, binder and dispersing medium. The positive electrode active material slurry was coated onto a positive electrode conductive support layer, dried and pressed, to form a positive electrode active material layer on the positive electrode conductive support layer.

A negative electrode active material slurry was prepared by mixing graphite as the negative electrode active material, and a sulfide solid electrolyte, conductive aid, binder and dispersing medium. The negative electrode active material slurry was coated onto a negative electrode conductive support layer, dried and pressed, to form a negative electrode active material layer on the negative electrode conductive support layer.

A sulfide solid electrolyte, binder and dispersing medium were mixed to prepare a solid electrolyte slurry. The solid electrolyte slurry was coated onto a substrate, dried and pressed to form a solid electrolyte layer on the substrate.

The solid electrolyte layer was then layered on the negative electrode active material layer and roll pressed to transfer the solid electrolyte layer onto the negative electrode active material layer. Next, the positive electrode active material layer was layered on the solid electrolyte layer and subjected to isostatic pressing to join their interfaces and form a stack.

Specifically, the stack had the structure shown in FIG. 8.

The stack in FIG. 8 has a positive electrode conductive support layer 318, a positive electrode active material layer 312, a solid electrolyte layer 313, a negative electrode active material layer 314 and a negative electrode conductive support layer 319, in that order.

The structural unit cell for Example 1 was completed by placing the positive electrode collector layer on one side and the negative electrode collector layer on the other side of the stack in FIG. 8.

### Example 2

A stack such as shown in FIG. 8 was formed in the same manner as Example 1.

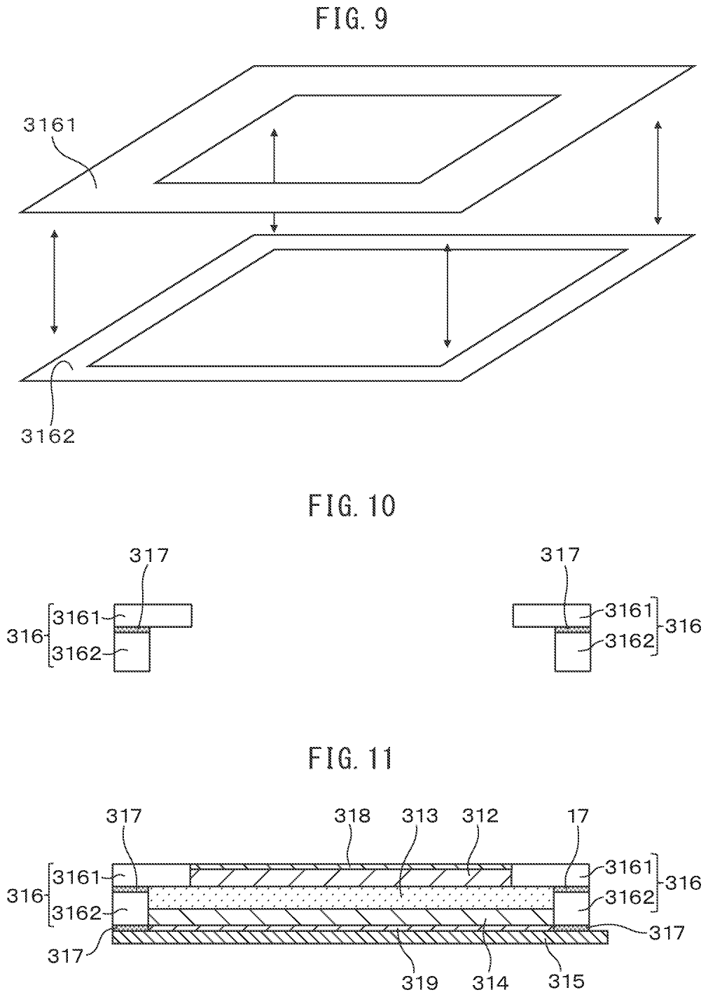

Next, as shown in FIGS. 9 and 10, hollow portions were cut out of polyimide sheets as the first insulation frame member 3161 and second insulation frame member 3162, and they were bonded together with a bonding agent 317 to form an insulation frame 316.

As shown in FIG. 11, the insulation frame 316 was then placed on the positive electrode conductive support layer 318 side of the stack and the insulation frame 316 and negative electrode collector layer 315 were bonded with a bonding agent 317.

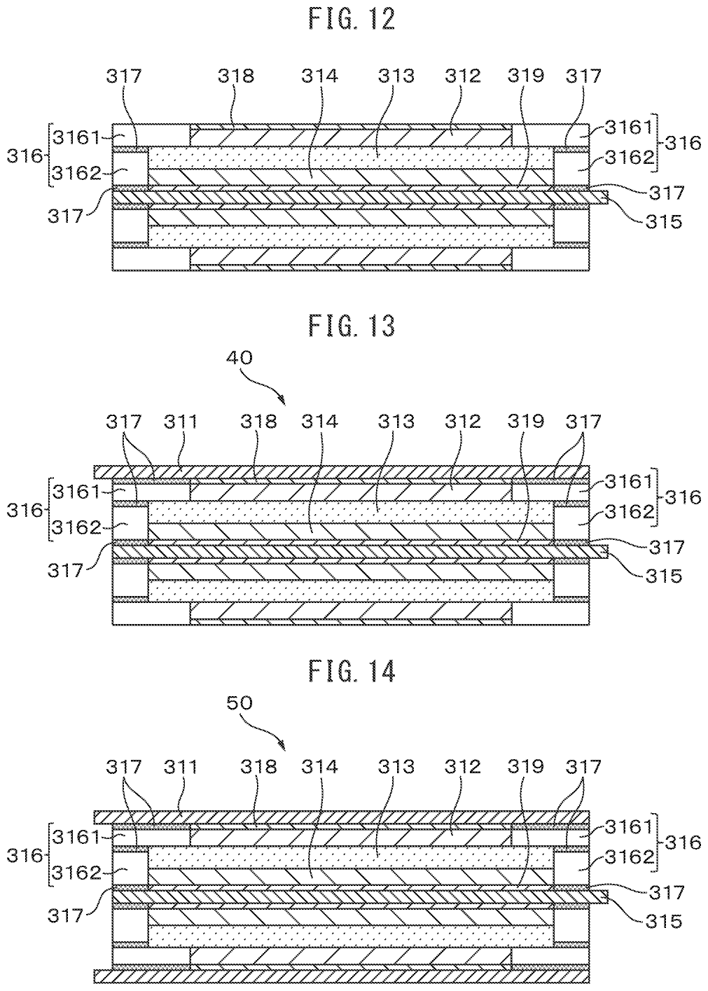

Next, as shown in FIG. 12, another stack was layered on the negative electrode collector layer 315 side of the stack, to create a stack having two anchored unit cells.

As shown in FIGS. 13 and 14, a stack having the positive electrode collector layer 311 on one positive electrode conductive support layer 318 of the stack comprising the two unit cells was used as stack 40 (FIG. 13), and a stack having the positive electrode collector layer 311 on both positive electrode conductive support layers 318 was used as stack 50 (FIG. 14). Four of the stack 40 were fabricated, and one of the stack 50 was fabricated.

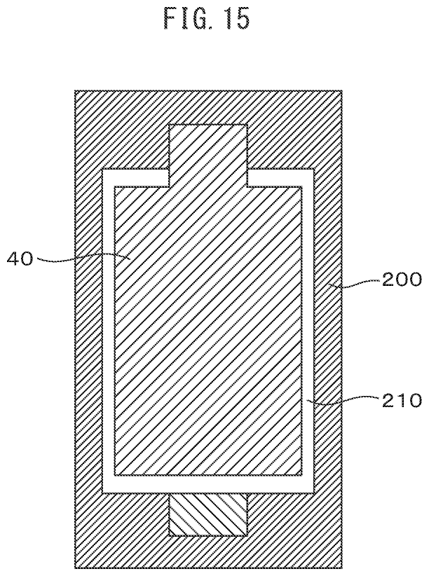

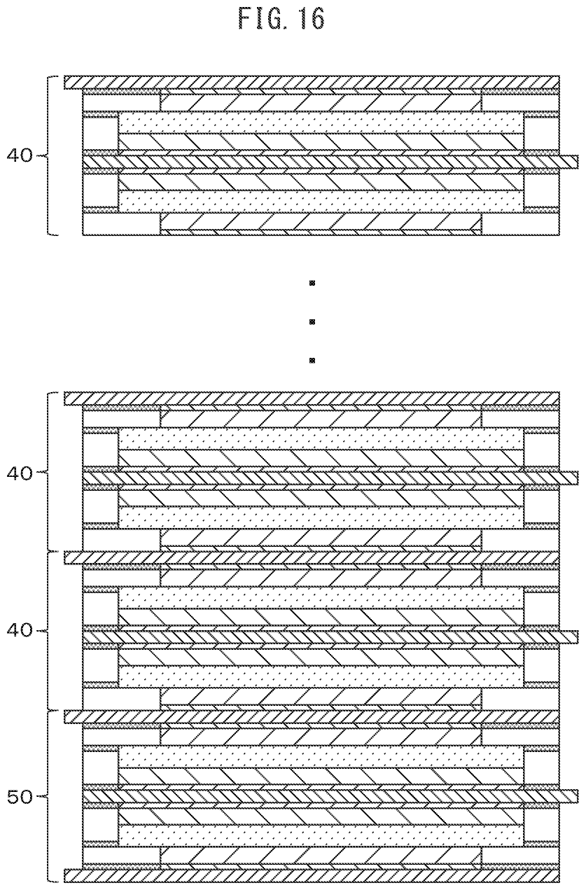

Next, as shown in FIG. 15, the four stacks 40 and the one stack 50 were placed in the hollow portion 210 of the positioning jig 200. The first insulation frame member 3161 of the stack 40 on one side and the positive electrode collector layer 311 of the stack 40 on the other side, which were adjacent, and the first insulation frame member 3161 of the stack 40 and the positive electrode collector layer 311 of the stack 50, which were adjacent, were bonded together with a bonding agent 317 to join each stack 40 and stack 50 Specifically, as shown in FIG. 16, four stacks 40 were layered with the stack 50 at the bottom.

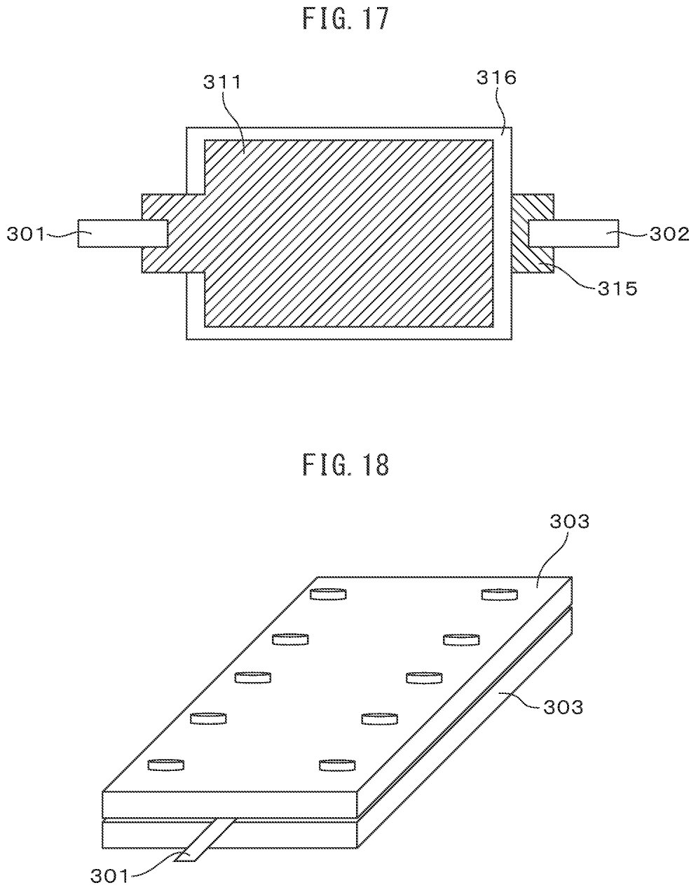

Next, as shown in FIG. 17, a positive electrode collector tab 301 was joined to each positive electrode collector layer 311 and a negative electrode collector tab 302 was joined to each negative electrode collector layer 315.

Finally, as shown in FIG. 18, both sides in the stacking direction were constrained by end plates 303, to complete the all-solid-state battery stack.

The all-solid-state battery stack of Example 2 has ten structural unit cells stacked.

### <Charge-Discharge Test>

The structural unit cell of Example 1 and the all-solid-state battery stack of the Example 2 were subjected to charge-discharge once at 25° C. with a discharge rate of 0.1 C. Each was again subjected to charge-discharge again under the same conditions, and the charge capacity and discharge capacity were measured.

The measurement results are shown in Table 1 below.

TABLE 1

| | | | Charge | Discharge | Charge-discharge |
|---|---|---|---|---|---|
| | Charge | Discharge | capacity per unit | capacity per unit | coulombic |
| | capacity | capacity | structural unit cell | structural cell | efficiency |
| Example | (mAh) | (mAh) | (mAh) | (mAh) | (%) |
| Example 1 | 159 | 158 | 159 | 158 | 99.6 |
| Example 2 | 1528 | 1513 | 153 | 151 | 99.0 |

As shown in Table 1, the charge capacity and discharge capacity per structural unit cell for the structural unit cell of Example 1 were 159 mAh and 158 mAh, respectively. In contrast, the charge capacity and discharge capacity per structural unit cell for the all-solid-state battery stack of Example 2 were 153 mAh and 151 mAh, respectively. The charge capacity and discharge capacity per structural unit cell for the all-solid-state battery stack of Example 2 were both lower compared to the structural unit cell of Example 1. However, the difference was only slight at about 4%.

In addition, the charge-discharge efficiency of the all-solid-state battery stack of Example 2 was 99%, indicating that the all-solid-state battery stack of Example 2 had not short circuited.

### <X-Ray CT Analysis>

Examination of the internal structure of the all-solid-state battery stack of Example 2 by X-ray CT showed 1 mm of dislocation of the positive electrodes. This corresponded to a difference of 1 mm between the dimensions of the inner periphery of the first insulating film and the dimensions of the positive electrode, confirming that dislocation was within the expected range. In addition, no damage was observed in the edges of the negative electrode active material layers. This indicates that excessive bending of the edges of the negative electrode active material layer was prevented by filling the gap formed by the insulation frame due to differences in the sizes of the positive electrode active material layer and the solid electrolyte layer and negative electrode active material layer in the in-plane direction.

### <Measurement of Contact Pressure Distribution>

When a sheet-like contact pressure sensor was inserted between the structural unit cell and end plate and constrained with bolts, and the contact pressure distribution was measured, it was confirmed that the contact pressure was applied only at the portions where the positive electrode active material layers overlapped in the stacking direction, as intended. This was an effect of reducing dislocation of the positive electrode active material layers, and reducing the thicknesses of the first insulation frame member and second insulation frame member to be smaller than the thicknesses of the positive electrode active material layer (including the positive electrode conductive support layer) and negative electrode active material layer (including the negative electrode conductive support layer), respectively.

### REFERENCE SIGNS LIST

10 Structural unit cell
11 First current collector layer
11 a Current collector
11b Collector tab
12 First active material layer
13 Solid electrolyte layer
14 Second active material layer
15 Second current collector layer
15a Current collector
15b Collector tab
16 Insulation frame
16a Hollow portion
16b Frame portion
161 First insulation frame member
162 Second insulation frame member
17 Bonding agent
18 First conductive support layer
19 Second conductive support layer
100, 100′ All-solid-state battery stack
200 Positioning jig
210 Hollow portion

1. A structural unit cell comprising a first current collector layer, a first active material layer, a solid electrolyte layer, a second active material layer and a second current collector layer stacked in that order, and
having an insulation frame which:
is disposed surrounding the outer periphery of the first active material layer, and
is bonded to the first current collector layer and/or second current collector layer, wherein, as seen from the stacking direction,
the first active material layer is disposed on the inner side of the outer periphery of the second active material layer, and
the insulation frame has its inner periphery on the inner side of the outer periphery of the second active material layer.

2. The structural unit cell according to claim 1, wherein
the insulation frame has:
a first insulation frame member which:
is disposed surrounding the outer periphery of the first active material layer and
is bonded to the first current collector layer, and
a second insulation frame member which:
is disposed surrounding the outer periphery of the second active material layer and is bonded to the second current collector layer,
wherein the first insulation frame member and the second insulation frame member are bonded together.

3. The structural unit cell according to claim 2, wherein:
a first conductive support layer is disposed between the first current collector layer and the first active material layer, and
the thickness of the first insulation frame member is no greater than the total of the thicknesses of the first active material layer and the first conductive support layer.

4. The structural unit cell according to claim 2, wherein:
a second conductive support layer is disposed between the second current collector layer and the second active material layer, and
the thickness of the second insulation frame member is no greater than the total of the thicknesses of the second active material layer and the second conductive support layer.

5. An all-solid-state battery stack in which a plurality of structural unit cells according to claim 1 are stacked,
wherein the structural unit cells are disposed so that the outer peripheries of the respective insulation frames are aligned, as seen from the stacking direction.

6. A method for producing an all-solid-state battery stack, wherein the method includes stacking a plurality of structural unit cells according to claim 1 at the hollow portion of a positioning jig having a hollow portion that is complementary to the outer periphery of the insulation frame.
